(19) United States
(12) Patent Application Publication
(10) Pub. No.: US 2023/0328839 A1
(43) Pub. Date: Oct. 12, 2023

(54) TECHNIQUES FOR MANAGEMENT OF FEEDBACK BASED RADIO LINK FAILURE IN UNLICENSED SIDELINK

(71) Applicant: QUALCOMM Incorporated, San Diego, CA (US)

(72) Inventors: Yisheng XUE, San Diego, CA (US); Xiaoxia ZHANG, San Diego, CA (US); Chih-Hao LIU, San Diego, CA (US); Jing SUN, San Diego, CA (US); Ozcan OZTURK, San Diego, CA (US)

(21) Appl. No.: 17/658,192

(22) Filed: Apr. 6, 2022

(51) Int. Cl. H04W 76/28; H04W 24/08; H04L 1/18; H04L 5/00

(52) U.S. Cl. CPC H04W 76/28; H04W 24/08; H04W 92/18; H04L 5/0053; H04L 1/1812

(57) ABSTRACT

Various aspects of the present disclosure generally relate to wireless communication. In some aspects, a wireless node may configure, for a sidelink unicast link, a feedback response window including a plurality of feedback occasions associated with a communication channel. The wireless node may transmit a communication on the communication channel. The wireless node may monitor for feedback on the plurality of feedback occasions based at least in part on a discontinuous transmission counter, wherein the discontinuous transmission counter is based at least in part on the feedback being associated with the feedback response window. Numerous other aspects are described.

### FIELD OF THE DISCLOSURE

Aspects of the present disclosure generally relate to wireless communication and to techniques and apparatuses for management of feedback based radio link failure in an unlicensed sidelink.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a wireless node. The method may include configuring, for a sidelink unicast link, a feedback response window including a plurality of feedback occasions associated with a communication channel. The method may include transmitting a communication on the communication channel. The method may include monitoring for feedback on the plurality of feedback occasions based at least in part on a discontinuous transmission counter, wherein the discontinuous transmission counter is based at least in part on the feedback being associated with the feedback response window.

Some aspects described herein relate to a wireless node for wireless communication. The wireless node may include a memory and one or more processors coupled to the memory. The one or more processors may be configured to configure, for a sidelink unicast link, a feedback response window including a plurality of feedback occasions associated with a communication channel. The one or more processors may be configured to transmit a communication on the communication channel. The one or more processors may be configured to monitor for feedback on the plurality of feedback occasions based at least in part on a discontinuous transmission counter, wherein the discontinuous transmission counter is based at least in part on the feedback being associated with the feedback response window.

Some aspects described herein relate to a non-transitory computer-readable medium that stores a set of instructions for wireless communication by a wireless node. The set of instructions, when executed by one or more processors of the wireless node, may cause the wireless node to configure, for a sidelink unicast link, a feedback response window including a plurality of feedback occasions associated with a communication channel. The set of instructions, when executed by one or more processors of the wireless node, may cause the wireless node to transmit a communication on the communication channel. The set of instructions, when executed by one or more processors of the wireless node, may cause the wireless node to monitor for feedback on the plurality of feedback occasions based at least in part on a discontinuous transmission counter, wherein the discontinuous transmission counter is based at least in part on the feedback being associated with the feedback response window.

Some aspects described herein relate to an apparatus for wireless communication. The apparatus may include means for configuring, for a sidelink unicast link, a feedback response window including a plurality of feedback occasions associated with a communication channel. The apparatus may include means for transmitting a communication on the communication channel. The apparatus may include means for monitoring for feedback on the plurality of feedback occasions based at least in part on a discontinuous transmission counter, wherein the discontinuous transmission counter is based at least in part on the feedback being associated with the feedback response window.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of a slot structure, in accordance with the present disclosure.

FIG. 6 is a diagram illustrating an example of hybrid automatic repeat request (HARQ) discontinuous transmission (DTX), in accordance with the present disclosure.

FIG. 7 is a diagram illustrating an example of a feedback response window for sidelink feedback transmission, in accordance with the present disclosure.

FIG. 8 is a diagram illustrating an example of signaling associated with radio link failure (RLF) detection using a feedback response window, in accordance with the present disclosure.

FIGS. 9-11 are diagrams illustrating examples of a DTX counter associated with a feedback response window, in accordance with the present disclosure.

FIG. 12 is a diagram illustrating an example process performed, for example, by a wireless node, in accordance with the present disclosure.

FIG. 13 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

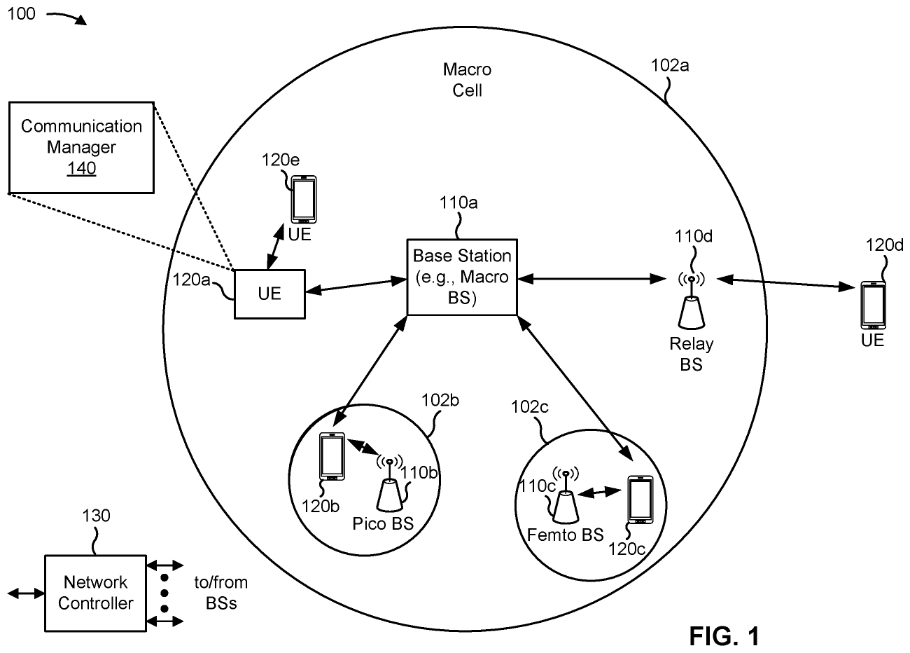

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a wireless node may include a communication manager 140. As described in more detail elsewhere herein, the communication manager 140 may configure, for a sidelink unicast link, a feedback response window including a plurality of feedback occasions associated with a communication channel; transmit a communication on the communication channel; and monitor for feedback on the plurality of feedback occasions based at least in part on a discontinuous transmission counter, wherein the discontinuous transmission counter is based at least in part on the feedback being associated with the feedback response window. Additionally, or alternatively, the communication manager 140 may perform one or more other operations described herein.

Deployment of communication systems, such as 5G New Radio (NR) systems, may be arranged in multiple manners with various components or constituent parts. In a 5G NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), evolved NB (eNB), NR base station (BS), 5G NB, gNodeB (gNB), access point (AP), transmit receive point (TRP), or cell), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more central units (CUs), one or more distributed units (DUs), one or more radio units (RUs), or a combination thereof).

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

As indicated above, FIG. 1 is provided as an example. Other examples may differ from what is described with regard to FIG. 1.

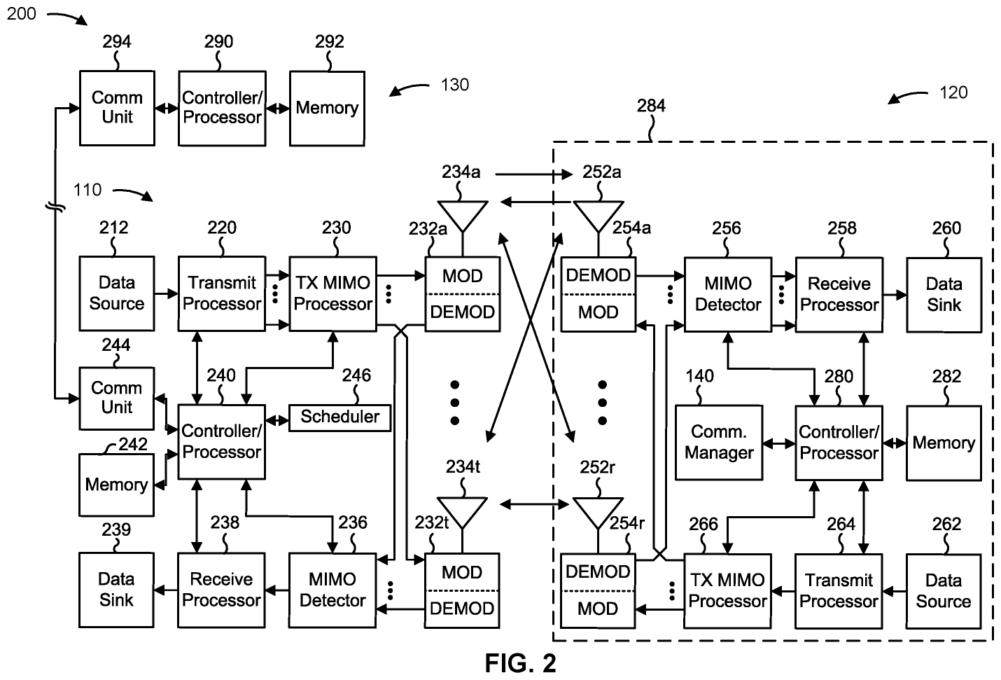

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

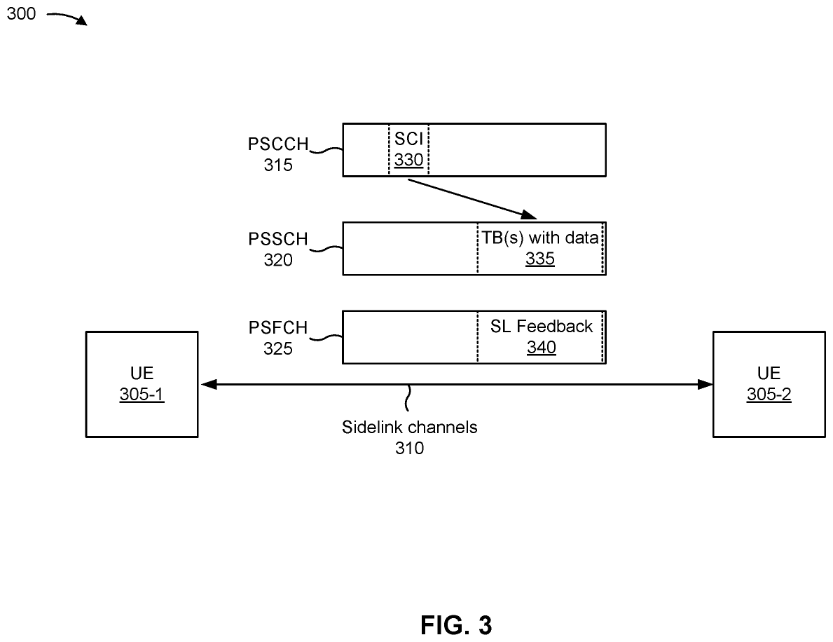

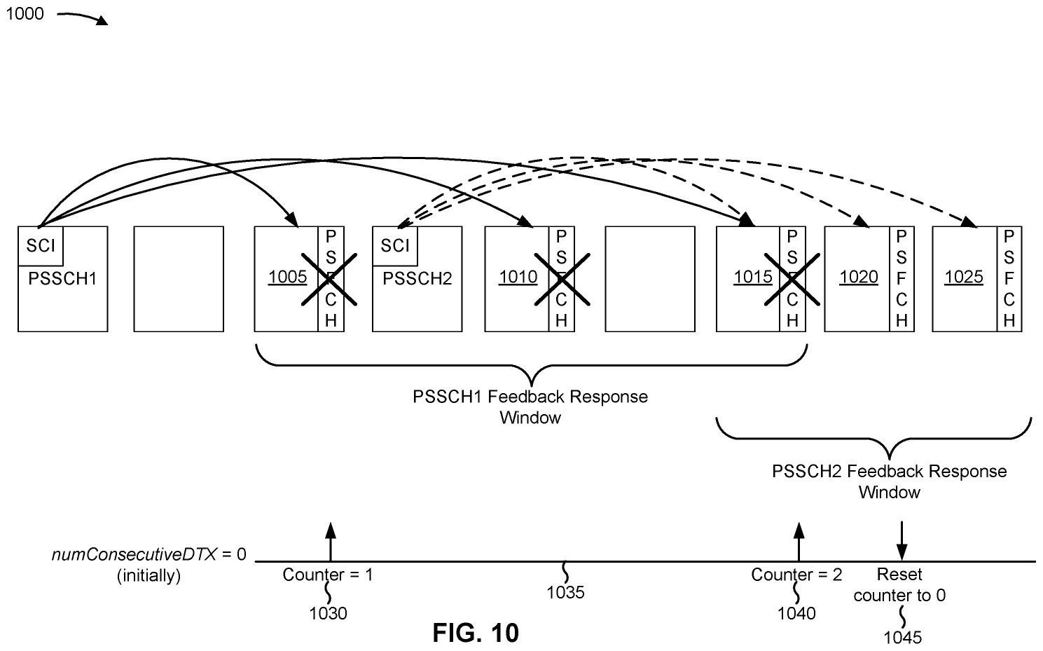

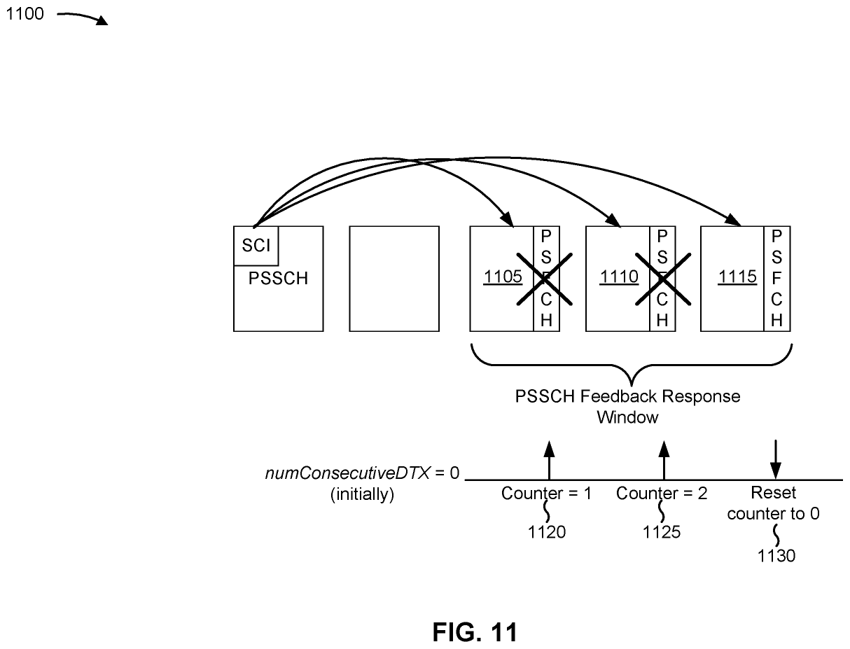

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-13).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-13).

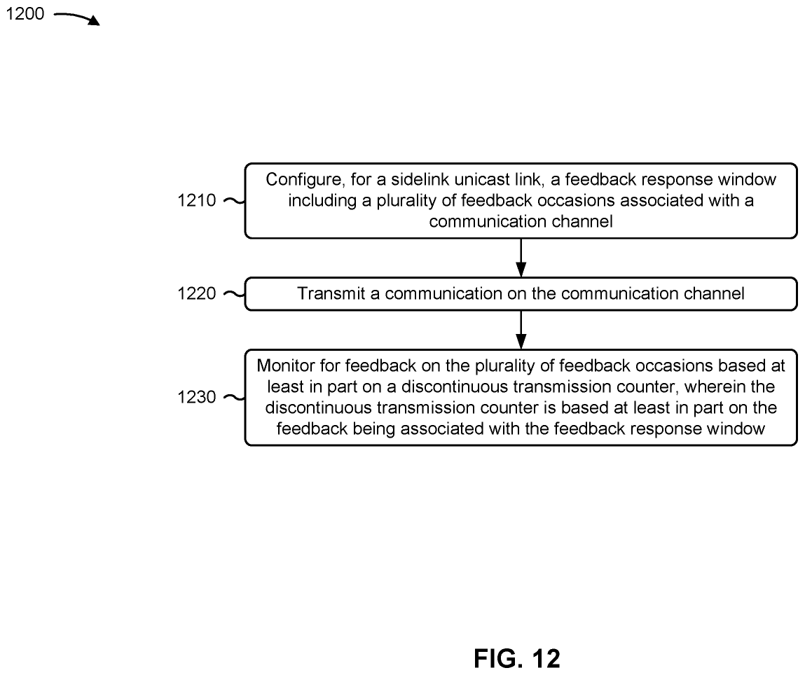

The controller/processor 240 of the base station 110, the controller/processor 280 of the UE 120, and/or any other component(s) of FIG. 2 may perform one or more techniques associated with a feedback response window, as described in more detail elsewhere herein. For example, the controller/processor 240 of the base station 110, the controller/processor 280 of the UE 120, and/or any other component(s) of FIG. 2 may perform or direct operations of, for example, process 1200 of FIG. 12, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1200 of FIG. 12, and/or other processes as described herein. In some examples, executing instructions may include running the instructions, converting the instructions, compiling the instructions, and/or interpreting the instructions, among other examples.

In some aspects, the wireless node includes means for configuring, for a sidelink unicast link, a feedback response window including a plurality of feedback occasions associated with a communication channel; means for transmitting a communication on the communication channel; and/or means for monitoring for feedback on the plurality of feedback occasions based at least in part on a discontinuous transmission counter, wherein the discontinuous transmission counter is based at least in part on the feedback being associated with the feedback response window. In some aspects, the means for the wireless node to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARD) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARD) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a base station 110. For example, the UE 305 may receive a grant (e.g., in downlink control information (DCI) or in a radio resource control (RRC) message, such as for configured grants) from the base station 110 for sidelink channel access and/or scheduling. In some aspects, a UE 305 may operate using a transmission mode (e.g., Mode 2) where resource selection and/or scheduling is performed by the UE 305 (e.g., rather than a base station 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

Additionally, or alternatively, the UE 305 may perform listen-before-talk (LBT) for detecting if a channel is occupied by another device, which may be used for the UE 305 to determine to access the channel on a shared spectrum (e.g., an unlicensed spectrum). For example, some spectrum may be associated with a decentralized channel access mechanism (e.g., a clear channel assessment (CCA) procedure), whereby devices perform a channel access procedure to gain access to a channel of the spectrum. The channel access procedure may include an LBT. The parameters for the LBT may be indicated by an LBT category. An LBT category may define a channel sensing duration during which a device contending for access to a channel performs a CCA procedure. The channel sensing duration may indicate a length of time during which the device detects or senses an energy level on the channel to determine whether the energy level is less than (or equal to) a threshold. If the energy level is less than (or equal to) the threshold, then the LBT/CCA procedure is successful, and the device transmits a communication. If the energy level is greater than (or equal to) the threshold, then the CCA procedure is unsuccessful and the device may wait for a period of time (e.g., a backoff duration) before performing the CCA procedure again. Example LBT categories include category one (Cat 1) LBT, category two (Cat 2) LBT, category three (Cat 3) LBT, and category four (Cat 4) LBT. In Cat 1 LBT, also referred to as no LBT, an LBT procedure is not performed prior to transmission of a communication on the channel. In Cat 2 LBT, the channel sensing duration is fixed (e.g., without random back-off). For example, a 16 microsecond channel sensing duration is used for 16 microsecond Cat 2 LBT, and a 25 microsecond channel sensing duration is used for 25 microsecond Cat 2 LBT. In Cat 3 LBT, the channel sensing duration is fixed (e.g., a contention window has a fixed size), and random back-off is used. In Cat 4 LBT, the channel sensing duration is variable (e.g., a contention window has a variable size), and random back-off is used. Decentralized channel access mechanisms can cause some uncertainty in whether a device will successfully secure channel access for a given communication. For example, a device may fail to secure channel access and may therefore be unable to transmit sidelink feedback via a PSFCH on a feedback occasion. Techniques described herein provide a feedback response window with multiple feedback occasions, which reduces the likelihood that a failure to secure channel access causes a failure of transmission of sidelink feedback regarding a given communication.

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

In some cases, the UE 305-1 or the UE 305-2 may detect an RLF in one or more of the sidelink channels 310. The RLF may be detected based at least in part on a number of consecutive HARQ DTX occurrences. Techniques described herein provide counting of HARQ DTX occurrences for the purpose of declaring RLF when a feedback response window, including a plurality of feedback occasions, is used.

As indicated above, FIG. 3 is provided as an example. Other examples may differ from what is described with respect to FIG. 3.

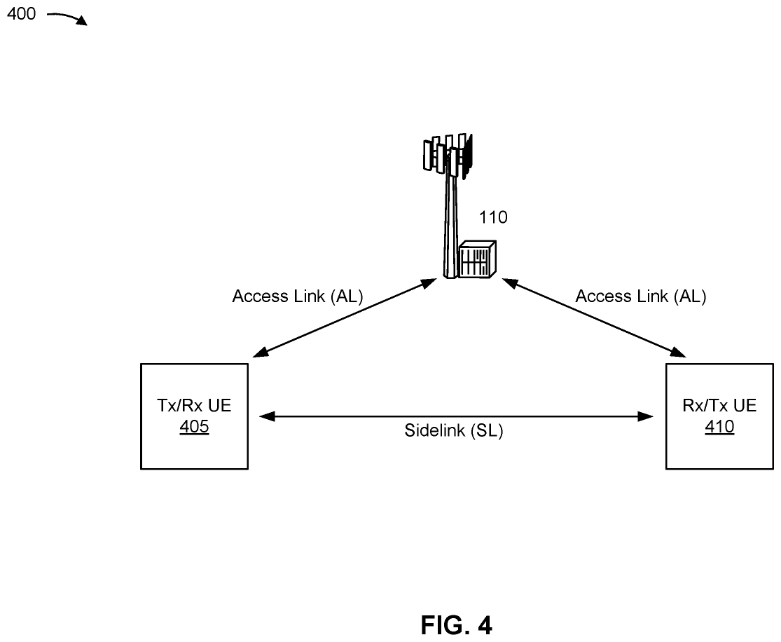

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110). As mentioned above, the sidelink may be associated with a decentralized channel access mechanism. Techniques described herein provide a feedback response window that can include multiple feedback occasions, which improves reliability of feedback regarding sidelink communications. Furthermore, techniques described herein provide counting of DTX in association with the feedback response window, which eliminates ambiguity with regard to how RLF should be declared in the context of a feedback response window with multiple feedback occasions.

As indicated above, FIG. 4 is provided as an example. Other examples may differ from what is described with respect to FIG. 4.

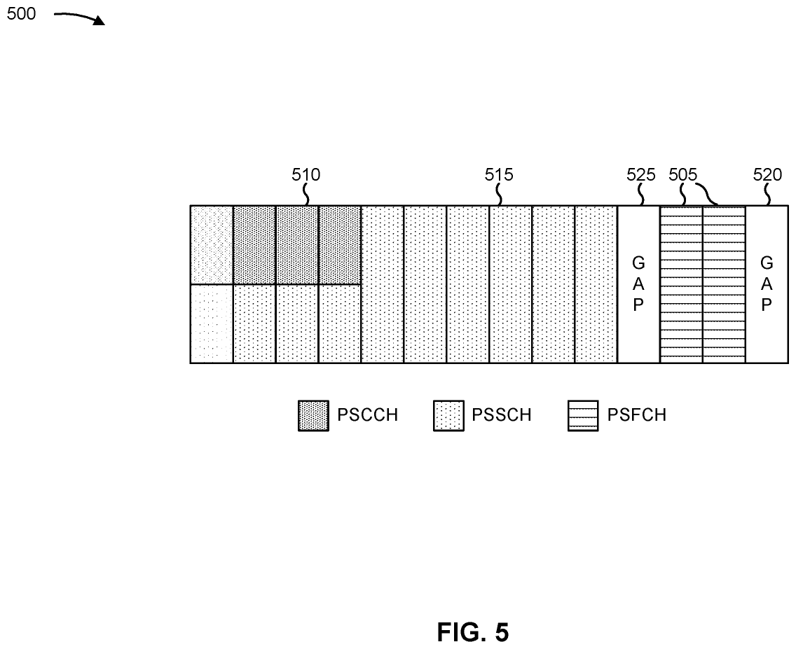

FIG. 5 is a diagram illustrating an example 500 of a slot structure, in accordance with the present disclosure. The slot structure may be used for a slot on the sidelink.

A slot may be configured with feedback resources 505. The slot may include 14 OFDM symbols, which are distributed horizontally in FIG. 5. The slot may include a PSCCH 510, a PSSCH 515, and a PSFCH (corresponding to the feedback resources 505). Resources for the PSFCH may be configured with a period of 0, 1, 2, or 4 slots. As shown, the PSFCH may include two OFDM symbols, which may include a first OFDM symbol dedicated to the PSFCH and a second OFDM symbol for automatic gain control (AGC) purposes. A gap symbol 520 may be present after the PSFCH. A gap symbol 525 may be present before the PSFCH, and may facilitate Tx/Rx switching. With a 30 kHz or 15 kHz subcarrier spacing, the gap symbol may be long enough to interrupt a channel occupancy time (COT) of a UE, thereby leading to a loss of channel access when using a decentralized channel access mechanism. Therefore, a UE seeking to transmit feedback on the PSFCH may have to perform LBT for the PSFCH, thereby causing uncertainty in the transmission of the feedback.

As indicated above, FIG. 5 is provided as an example. Other examples may differ from what is described with respect to FIG. 5.

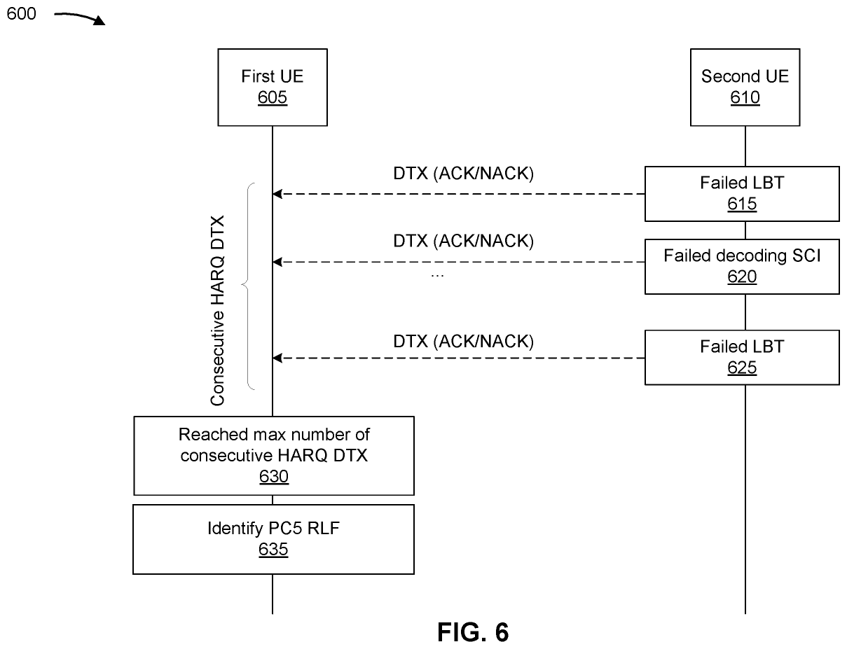

FIG. 6 is a diagram illustrating an example 600 of HARQ DTX, in accordance with the present disclosure. A first UE, such as the first UE 605, may communicate with a second UE, such as the second UE 610. The first UE 605 and the second UE 610 may include some or all of the features of the UE 120, 305, 405, or 410.

In some cases, the first UE 605 and the second UE 610 may communicate via sidelink. For example, the first UE 605 may transmit or receive sidelink unicast communications from the second UE 610, and the second UE 610 may transmit or receive sidelink unicast communications from the first UE 605. The sidelink communications may be transmitted or received over the PC5 interface. The sidelink communications may be received or transmitted over a sidelink unicast link, which may be established and maintained via PC5-RRC signaling. Sidelink unicast communications may be associated with a feedback mechanism. For example, an SCI transmitted by the first UE 605 may include a request for a HARQ response for a given communication (e.g., a PSSCH communication) scheduled by the SCI. Based at least in part on receiving the request, the second UE 610 may transmit a HARQ response over the corresponding PSFCH (where the HARQ response can indicate an acknowledgment (ACK) or a negative acknowledgment (NACK) for the given communication). If the second UE 610 fails to decode the SCI, the first UE 610 may have a DTX at a corresponding feedback occasion.

In some cases, an RLF for radio access link (Uu) communications between the first UE 605 (or the second UE 610) and the base station 110 may be detected based at least in part on a synchronization signal block (SSB) or CSI reference signal (CSI-RS). For example, one or more characteristics of the SSB or CSI-RS, or a failure to receive the SSB or CSI-RS, may indicate that the channel quality is poor, and that an RLF should be declared. However, sidelink RLF may be more difficult to properly detect since a sidelink SSB or sidelink CSI-RS may not be always available for radio link measurements. For example, transmitting and receiving a CSI-RS via sidelink among many UEs in proximity may result in significant signaling overhead.

In some cases, a sidelink RLF may be detected by the first UE 605 (or the second UE 610) based at least in part on an indication from a sidelink radio link control (RLC) entity that a maximum number of retransmissions for a specific destination has been reached. In some cases, the sidelink RLF may be detected based at least in part on an expiration of a timer, such as a T400 timer for RRCReconfigurationSidelink. In some cases, the sidelink RLF may be detected based at least in part on an indication from a MAC entity to an RRC entity that a maximum number of consecutive HARQ DTX occurrences (such as a maximum number specified by a parameter sl-maxNumConsecutiveDTX, and based at least in part on a counter numConsecutiveDTX) for a specific destination (e.g., unicast connection) has been reached. For example, if PSFCH reception is absent on a given PSFCH reception occasion, the UE may increment numConsecutiveDTX by 1. If the first UE 605 receives HARQ feedback (e.g., receives any HARQ feedback, or receives HARQ feedback that does not indicate a DTX), then the first UE 605 may reset the counter to zero. In some cases, the sidelink RLF may be detected based at least in part on an integrity check failure indication from a sidelink packet data convergence protocol (PDCP) entity concerning a sidelink signaling radio bearer (SL-SRB), such as SL-SRB2 or SL-SRB3, for a specific destination.

In some cases, the first UE 605 (or the second UE 610) may be configured to perform one or more of a plurality of actions based at least in part on detecting the sidelink RLF. For example, the first UE 605 may be configured to release the data radio bearers (DRBs) of the destination, release the SRBs of the destination, discard the NR sidelink communication related configuration of the destination, reset the sidelink specific MAC of the destination, consider the PC5-RRC connection to be released for the destination, or indicate the release of the PC5-RRC connection to the upper layers for the destination, among other examples.

In some cases, in a shared or unlicensed frequency band, the first UE 605 (or the second UE 610) may contend against other devices for channel access before transmitting on a shared or unlicensed channel to reduce and/or prevent collisions on the shared or unlicensed channel. To contend for channel access, the first UE 605 may perform a channel access procedure, such as an LBT procedure or another type of channel access procedure, for shared or unlicensed frequency band channel access. If the first UE 605 determines that the channel access procedure was successful, the first UE 605 may perform one or more transmissions on the shared or unlicensed channel during a transmission opportunity (TXOP), which may extend for a COT.

As shown in the example 600, a sidelink RLF may be detected based at least in part on one or more consecutive HARQ DTX occurrences. For example, the second UE 610 may fail to send an ACK or NACK in accordance with the HARQ process. The first UE 605 may detect or identify the RLF based at least in part on a certain number of consecutive HARQ DTX occurrences. For example, the first UE 605 may determine that a number of consecutive HARQ DTX occurrences (e.g., consecutively missing ACK or NACK feedback messages) is greater than a maximum number of consecutive HARQ DTX occurrences, and may identify the RLF based at least in part on the determination. A HARQ DTX occurrence may result from a first failed LBT procedure by the second UE 610, the second UE 610 failing to successfully decode the SCI, or the like, as shown by reference numbers 615, 620, and 625.

As shown in connection with reference number 630, the first UE 605 may determine that a maximum number of consecutive HARQ DTX occurrences has been reached. For example, the maximum number of consecutive HARQ DTX occurrences may be three consecutive HARQ DTX occurrences.

As shown in connection with reference number 635, the first UE 605 may identify the sidelink RLF based at least in part on the number of consecutive HARQ DTX occurrences being greater than, or greater than or equal to, the maximum number of HARQ DTX occurrences. If the sidelink RLF is due to a number of failed LBT procedures, the failed LBT procedures may simply be a result of the channel being busy. For example, the channel quality may be acceptable but may be busy as the channel is being used by another device, such as a Wi-Fi enabled device. As described herein, frequent sidelink RLF detection is undesirable. For example, sidelink RLF detections may cause disruptions to communications that are using the channel. This is particularly true when the sidelink RLF is detected on a channel that does not necessarily have poor channel quality. Additionally, recovering the sidelink RLF may require a large number of UE resources. For example, in order to recover the channel, the first UE 605 may need to re-establish the PC5 RRC connection, re-set up radio bearers, and reconfigure sidelink communications, among other examples.

As indicated above, FIG. 6 is provided as an example. Other examples may differ from what is described with regard to FIG. 6.

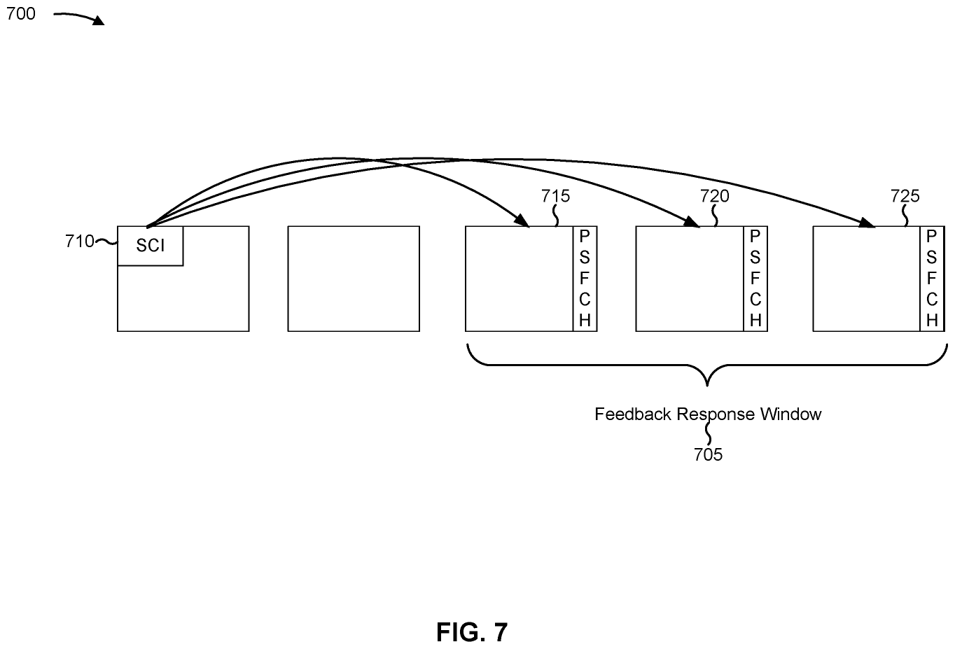

FIG. 7 is a diagram illustrating an example 700 of a feedback response window 705 for sidelink feedback transmission, in accordance with the present disclosure. Some techniques and apparatuses described herein provide a feedback response window 705 for a given communication 710 (e.g., a given PSSCH communication and/or PSCCH communication, such as a PSSCH communication scheduled by SCI). The feedback response window may include multiple feedback occasions 715, 720, and 725. Each feedback occasion 715, 720, 725 is associated with the given communication 710 (as indicated by an arrow between a feedback occasion and the SCI associated with the given communication 710), meaning that each feedback occasion 715, 720, 725 may carry feedback associated with the given communication 710. “Feedback occasion” may refer to a PSFCH designated for feedback associated with the communication 710, or to a slot including a PSFCH designated for feedback associated with the communication 710. Thus, for RLF detection for a unicast sidelink established over a band imposed with LBT (e.g., a band using a decentralized channel access mechanism), a transmitting (TX) UE and a receiving (RX) UE can define a feedback response window 705 to collect feedback (e.g., HARQ responses) for a PSSCH. The feedback response window 705 (sometimes referred to as a HARQ response window) can include multiple feedback occasions for HARQ responses. In some aspects, as illustrated in FIG. 7, the multiple feedback occasions are distributed in the time domain, meaning that at least two feedback occasions in the feedback response window occur at different times. In some aspects, the multiple feedback occasions are distributed in the frequency domain, meaning that at least two feedback occasions in the feedback response window occur at different frequencies.

In some aspects, the multiple feedback occasions and/or the feedback response window 705 are pre-configured (e.g., statically pre-configured). For example, a rule may indicate resources associated with the multiple feedback occasions. As another example, a rule may indicate which potential feedback occasions, in a feedback response window 705, are to be used as feedback occasions. As yet another example, a rule may indicate a feedback response window relative to a given communication 710 (e.g., a time and/or frequency window of the feedback response window), or may indicate multiple feedback occasions relative to the given communication 710. That is, in some cases, a feedback response window may not be explicitly defined, and feedback occasions may be defined. In this example, the feedback response window may be considered a frequency and/or time range that encompasses the multiple feedback occasions. In some aspects, the multiple feedback occasions and/or the feedback response window 705 may be dynamically triggered or re-triggered, meaning that the multiple feedback occasions and/or the feedback response window 705 may be defined in relation to a given communication 710 (such as based at least in part on a slot offset and/or subchannel offset relative to the given communication 710).

Feedback of the multiple feedback occasions can be carried over the PSFCH, or in SCI from the RX UE, as described in more detail below.

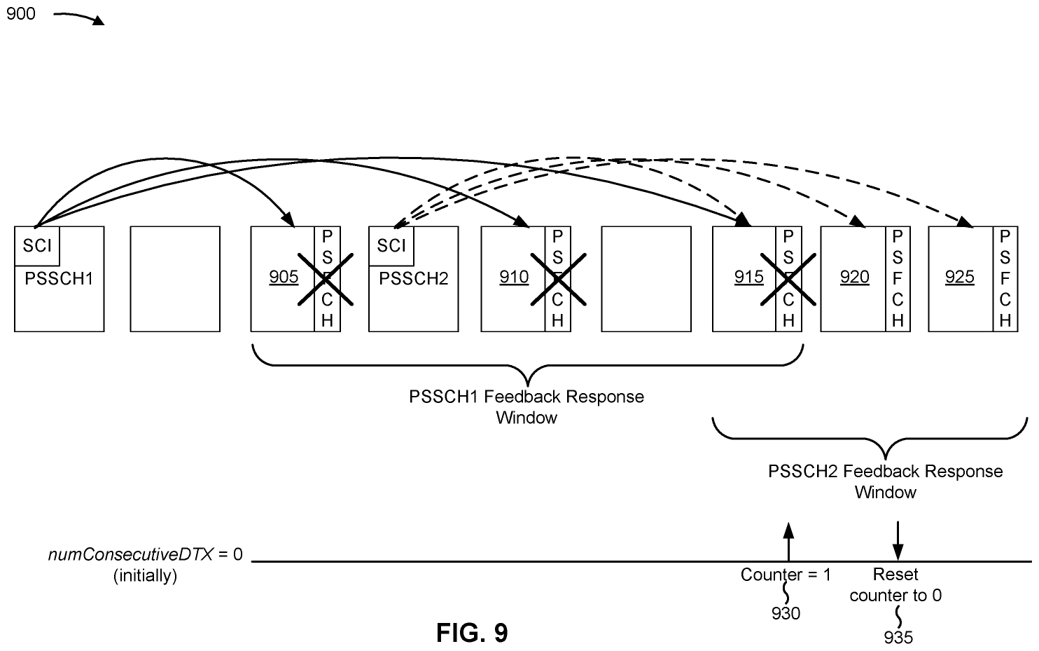

The TX UE may monitor for feedback on the multiple feedback occasions (e.g., may perform RLF detection for a sidelink unicast link with the RX UE) based at least in part on a DTX counter (e.g., numConsecutiveDTX). The DTX counter may be based at least in part on the feedback being associated with the feedback response window 705. For example, the DTX counter may use a counting technique that is based at least in part on the given communication 710 being associated with multiple feedback occasions. In one example, the TX UE may increment the DTX counter by 1 if the TX UE determines DTX for all feedback occasions within the feedback response window 705, or may reset the DTX counter if the TX UE receives feedback on at least one feedback occasion of the feedback response window 705. Other examples of counting techniques are provided in connection with FIGS. 9-11, below. By implementing the feedback response window 705, reliability of feedback and the occurrence of RLF on sidelink unicast links is reduced. By counting DTX occurrences based at least in part on the feedback being associated with the feedback response window 705, ambiguity regarding how DTX occurrences should be interpreted in view of a feedback response window 705 is reduced, and the occurrence of RLF on sidelink unicast links is reduced.

It should be noted that the techniques described herein can be applied for channels that do not use a decentralized channel access mechanism. For example, the feedback response window 705 and the multiple feedback occasions can be used for a case where the RX UE has difficulty closing the PSFCH link with a single feedback transmission (such as in a vehicle-to-vehicle context where different UEs may have different transmit power capabilities, particularly in unlicensed bands). As another example, the feedback response window 705 and the multiple feedback occasions can be used for a case where the TX UE is transmitting high priority or high reliability traffic, for which prompt and reliable delivery of HARQ feedback is of great importance.

As indicated above, FIG. 7 is provided as an example. Other examples may differ from what is described with regard to FIG. 7.

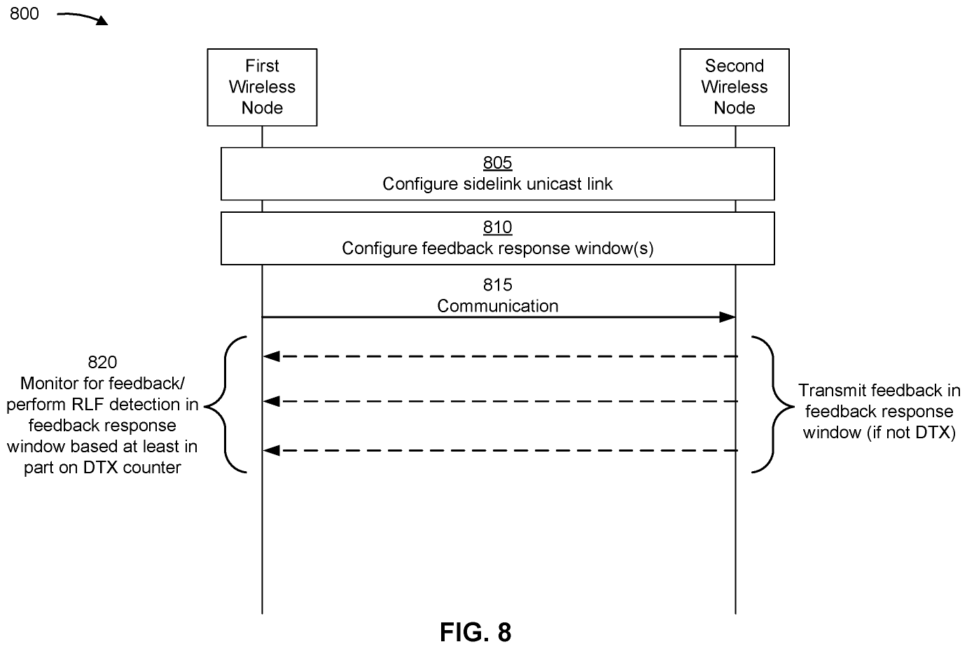

FIG. 8 is a diagram illustrating an example 800 of signaling associated with RLF detection using a feedback response window, in accordance with the present disclosure. Example 800 includes a first wireless node (e.g., UE 120, UE 305, UE 405, UE 410, UE 605, UE 610) and a second wireless node (e.g., UE 120, UE 305, UE 405, UE 410, UE 605, UE 610). In some examples, the first wireless node may be a TX UE that transmits a communication, and the second wireless node may be an RX UE that provides feedback regarding the communication.

As shown in FIG. 8, and by reference number 805, the first wireless node and the second wireless node may configure a sidelink unicast link. For example, the first wireless node and the second wireless node may exchange PC5-RRC signaling to establish a sidelink unicast link. In some aspects, the sidelink unicast link may be associated with a decentralized channel access mechanism. For example, the first wireless node and the second wireless node may use LBT to access a channel used for communication via the sidelink unicast link. In some other aspects, the sidelink unicast link may not be associated with a decentralized channel access mechanism.

As shown by reference number 810, the first wireless node and/or the second wireless node may configure a feedback response window. In some aspects, the first wireless node may configure the feedback response window for the second wireless node (e.g., the first wireless node may transmit information indicating one or more parameters associated with the feedback response window to the second wireless node). In some aspects, the second wireless node may configure the feedback response window for the first wireless node (e.g., the second wireless node may transmit information indicating one or more parameters associated with the feedback response window to the first wireless node). In some aspects, the first wireless node and the second wireless node may negotiate the feedback response window. For example, the first wireless node and the second wireless node may exchange information that is used by the first wireless node and the second wireless node to define the feedback response window. In some aspects, the first wireless node and the second wireless node may configure the feedback response window based at least in part on the sidelink unicast link being associated with the decentralized channel access mechanism. For example, if the sidelink unicast link uses spectrum associated with a decentralized channel access mechanism, then the first wireless node and/or the second wireless node may configure the feedback response window. The feedback response window may include a plurality of feedback occasions, as described in more detail elsewhere herein. In some aspects, the feedback response window may not include all opportunities for the first wireless node to receive feedback for a given PSSCH from the second wireless node (such as in the case of heterogeneous opportunities, as described elsewhere herein). In some aspects, the feedback response window may not include only opportunities for the first wireless node to receive feedback regarding the given PSSCH (e.g., the feedback response window may include opportunities relating to other channels).

In some aspects, the feedback response window may be configured by a network entity, such as a base station, a central unit, or a distributed unit. In some aspects, the feedback response window may be configured as part of establishing the sidelink unicast link. For example, during configuration of the sidelink unicast link, the first wireless node and the second wireless node may exchange signaling to configure the feedback response window.

As shown by reference number 815, the first wireless node may transmit a communication. For example, the first wireless node may transmit SCI via a PSCCH scheduling a PSSCH communication. As another example, the first wireless node may transmit the PSSCH communication. As used herein, “the communication” can refer to the SCI scheduling the PSSCH communication and/or to the PSSCH communication.

As shown by reference number 820, the first wireless node may monitor for feedback on the plurality of feedback occasions of the feedback response window. For example, the first wireless node may continuously search for a non-DTX response (e.g., an ACK or NACK) within the feedback response window. The first wireless node may perform RLF detection based at least in part on monitoring for the feedback. For example, the first wireless node may maintain a DTX counter. The DTX counter may be based at least in part on the feedback being associated with the feedback response window, as described elsewhere herein. If the DTX counter reaches a maximum number, the first wireless node may detect RLF, and may perform one or more actions described elsewhere herein.

In some aspects, the first wireless node may skip monitoring on a particular feedback occasion of the plurality of feedback occasions. For example, the first wireless node may not be available to perform reception at the particular feedback opportunity, such as due to higher priority traffic (e.g., to transmit a HARQ response pertaining to a higher-priority transport block received from another wireless node) or a PSFCH to receive. In some aspects, the first wireless node, the second wireless node, and/or a network entity may configure and/or use an approach for performing RLF detection based at least in part on skipping the monitoring on a particular feedback occasion (such as at reference number 810). In some aspects, the first wireless node may monitor for the feedback as if the particular feedback occasion did not exist. For example, the first wireless node may skip monitoring on the particular feedback occasion as if it did not exist, and may not increment a DTX counter for the particular feedback occasion. In some aspects, the first wireless node may monitor for the feedback assuming a non-DTX result on the particular feedback occasion. For example, the first wireless node may reset the DTX counter for the particular feedback occasion without monitoring for feedback on the particular feedback occasion. In some aspects, the first wireless node may monitor for the feedback assuming a DTX result on the particular feedback occasion. For example, the first wireless node may increment the DTX counter for the particular feedback occasion without monitoring for feedback on the particular feedback occasion. In some aspects, the first wireless node and/or the second wireless node may use one of the above approaches (e.g., monitor for the feedback as if the particular feedback occasion did not exist, monitor for the feedback assuming a non-discontinuous transmission result on the particular feedback occasion, or monitor for the feedback assuming a DTX result on the particular feedback occasion) based at least in part on a priority of the communication shown by reference number 815. For example, for a lower-priority communication, the first wireless node may increment the DTX counter only in a legacy PSFCH occasion and when the first wireless node actually performs the reception.

In some aspects, the first wireless node may monitor for only a non-DTX result on a particular feedback occasion, or for a DTX result on the particular feedback occasion, based at least in part on the configuration of the feedback response window. For example, some feedback occasions may be configured as feedback occasions where the first wireless node is to monitor for only non-DTX results, whereas other feedback occasions may be configured as feedback occasions where the first wireless node is to monitor for DTX results as well as non-DTX results. When monitoring for only non-DTX results, the first wireless node may not identify a DTX result. For example, the first wireless node may not increment the DTX counter if no feedback is detected. Thus, the feedback occasions can be configured heterogeneously. In one example, in a feedback response window including three feedback occasions, the first and third feedback occasions may be configured for monitoring for DTX results as well as non-DTX results, and the second feedback occasion may be configured for monitoring for only non-DTX results. The configuration of certain feedback occasions for only non-DTX results may facilitate autonomous selection of a feedback method by the second wireless node. For example, the second wireless node may autonomously transmit a HARQ response over SCI (rather than the PSFCH of a given feedback occasion) upon determining the risk of RLF (for example, if the second wireless node has failed LBT for a number of PSFCH opportunities). Configuring the given feedback occasion for only non-DTX results may prevent the first wireless node from determining RLF when no feedback would have been transmitted on the given feedback occasion.

In some aspects, the feedback may include a two-state HARQ codebook. A two-state HARQ codebook includes a bit indicating whether a cyclic redundancy check (CRC) of the communication 815 passed or failed. In some aspects, the first wireless node may monitor for feedback based at least in part on a two-state HARQ codebook. For example, the first wireless node may reset a DTX counter upon reception of a valid HARQ codebook that carries feedback regarding any HARQ process for which the first wireless node is awaiting feedback. As another example, the first wireless node may increment the DTX counter by a weighted number of NACKs in the HARQ codebook. The weighted number of NACKs may be derived from the total number of NACKs possible for the HARQ codebook. If the DTX counter reaches the maximum value, the first wireless node's MAC entity may indicate a HARQ based sidelink RLF detection to the first wireless node's RRC entity. In some aspects, the weighted number of NACKs may be based at least in part on a configuration between the first wireless node and the second wireless node, such as a configuration associated with unicast link establishment or a PC5-RRC configuration.

As shown by reference number 820, in some aspects, the first wireless node and/or the second wireless node may provide an indication of a selected mode for the feedback response window. For example, the first wireless node may transmit the indication to the second wireless node. As another example, the second wireless node may transmit the indication to the first wireless node. In some aspects, the configuration of the feedback response window may be based at least in part on the indication. For example, the first wireless node and/or the second wireless node may configure or reconfigure the feedback response window based at least in part on an indication of a selected mode. In some aspects, the selected mode may be based at least in part on a risk (e.g., likelihood) of RLF. Thus, the first wireless node and the second wireless node may implement an adaptive multiple feedback opportunity operation that consumes sidelink resources according to the risk of RLF. In some aspects, the indication may be provided via SCI that requests a HARQ response from the second wireless node. For example, the indication may be provided via SCI of the communication 815 (e.g., via a bit of the SCI). The first wireless node and the second wireless node may determine, such as via Layer 3 (e.g., RRC) signaling, how the indication maps to a selected mode.

In some aspects, the indication may indicate a selected mode from multiple modes. For example, the selected mode may be selected based at least in part on a risk of RLF. In some aspects, the selected mode may be based at least in part on the DTX counter. For example, if the DTX counter satisfies a threshold, or if a difference between the DTX counter and the maximum number of DTX occurrences associated with RLF is lower than a threshold, the first wireless node may provide an indication of a selected mode associated with a higher risk of RLF. If the DTX counter does not satisfy a threshold, or if a difference between the DTX counter and the maximum number of DTX occurrences associated with RLF is not lower than a threshold, the first wireless node may provide an indication of a selected mode associated with a lower risk of RLF. A selected mode associated with a higher risk of RLF may have more feedback opportunities in a given feedback response window than a selected mode associated with a lower risk of RLF.

In some aspects, the selected mode may indicate whether to duplicate transmission feedback (e.g., HARQ responses) over one or more feedback opportunities. For example, the selected mode may indicate whether to stop attempting transmission of feedback after a first successful LBT, or to duplicate transmission of feedback after a first successful LBT. When the selected mode indicates to stop after the first successful LBT, the second wireless node may attempt to transmit feedback at the soonest feedback occasion, and may stop transmission after a first successful LBT for the sake of power saving and reduced interference to other co-channel links. In this example, there may be only one transmission over the plurality of feedback occasions of the feedback response window. However, the first wireless node may miss the single feedback transmission due to half-duplex constraints, unfavorable fading, burst interference, or the like. When the selected mode indicates to duplicate transmission of the feedback, the second wireless node may attempt to transmit the HARQ response in any feedback occasion in which LBT is successful.

In some aspects, the selected mode may indicate whether to provide feedback over PSFCH or via SCI. For example, a HARQ response transmitted via SCI may be more reliable than a HARQ response transmitted via a PSFCH, but may be associated with larger overhead than a HARQ response transmitted via a PSFCH. Thus, it may be beneficial for the first wireless node and/or the second wireless node to switch between transmitting the feedback over the PSFCH and transmitting the feedback via the SCI. For example, the first wireless node may indicate a selected mode associated with feedback via SCI when adequate sidelink resources are available and/or when risk of RLF is high (e.g., when the DTX counter satisfies a threshold), and may indicate a selected mode associated with feedback over the PSFCH when sidelink resources are scarce and/or when risk of RLF is low.

In some aspects, the selected mode may indicate whether to use a two-state HARQ feedback codebook or a three-state HARQ feedback codebook. A three-state HARQ feedback codebook may include an indication of whether a given HARQ process is associated with three possible states, including an ACK state, a NACK state, or a DTX state. A three-state HARQ codebook may reduce the risk of a false alarm relative to a two-state HARQ codebook (which is associated with two possible states), and may be associated with larger overhead than a two-state HARQ codebook.

In some aspects, the first wireless node may transmit an indication, to a network entity, of a likelihood of a radio link failure of the sidelink unicast link. For example, when operating in Mode 1, the network entity may allocate sidelink resources for the first wireless node and the second wireless node. The indication of the likelihood of RLF may be based at least in part on the DTX counter (such as a threshold for the DTX counter or a threshold for a difference between the DTX counter and a maximum number of DTX occurrences). Upon receiving the indication, the network entity may grant sidelink resources that support the usage of the feedback response window. For example, the network entity may allocate a later resource for a physical uplink control channel (PUCCH) associated with indication of RLF to allow sufficient time for the first wireless node to identify a non-DTX HARQ response (e.g., after multiple feedback occasions). Thus, the occurrence of RLF in LBT based channels is reduced.

As indicated above, FIG. 8 is provided as an example. Other examples may differ from what is described with regard to FIG. 8.

FIGS. 9-11 are diagrams illustrating examples 900, 1000, and 1100 of a DTX counter associated with a feedback response window, in accordance with the present disclosure. Examples 900 and 1000 illustrate a first communication (PSSCH1) and a second communication (PSSCH2). The first communication may be associated with a first feedback response window (“Feedback response window of PSSCH1”) and the second communication may be associated with a second feedback response window (“Feedback response window of PSSCH2”). Example 1100 illustrates a single communication associated with a single feedback response window. The feedback response windows may be configured as described with regard to FIG. 8. In examples 900, 1000, and 1100, a wireless node may monitor for feedback based at least in part on a DTX counter, illustrated by the parameter numConsecutiveDTX. An upward arrow indicates that the DTX counter is incremented. A downward arrow indicates that the DTX counter is reset. The horizontal axis represents time. An “X” over a feedback occasion indicates a DTX on that feedback occasion.

In example 900, the first communication is associated with feedback occasions 905, 910, and 915. Furthermore, the second communication is associated with feedback occasions 915, 920, and 925. In example 900, the wireless node increments the DTX counter if no feedback is detected on any feedback occasion of the plurality of feedback occasions of a given communication. For example, at reference number 930, the wireless node increments the DTX counter from 0 to 1 based at least in part on no feedback being detected (e.g., DTX occurring) on each feedback occasion of the feedback response window associated with the first communication. Furthermore, the wireless node resets the DTX counter if the feedback is detected on any feedback occasion of the plurality of feedback occasions. For example, at reference number 935, the wireless node resets the DTX counter from 1 to 0 based at least in part on feedback being detected (e.g., non-DTX occurring) on any feedback occasion of the feedback response window associated with the second communication.

In example 1000, the first communication is associated with feedback occasions 1005, 1010, and 1015. Furthermore, the second communication is associated with feedback occasions 1015, 1020, and 1025. In example 1000, the wireless node increments the DTX counter if no feedback is detected on an earliest feedback occasion of the plurality of feedback occasions. For example, the wireless node may increment the DTX counter after, and only after, a first DTX in a feedback response window for a given PSSCH. For example, at reference number 1030, the wireless node increments the DTX counter from 0 to 1 based at least in part on no feedback being detected (e.g., DTX occurring) on a first feedback occasion of the feedback response window associated with the first communication. At reference number 1035, the wireless node does not increment the DTX counter (despite DTX occurring in feedback occasion 1010) since the DTX counter has already been incremented for the feedback response window associated with the first communication. At reference number 1040, the wireless node increments the DTX counter from 1 to 2 based at least in part on no feedback being detected (e.g., DTX occurring) on a first feedback occasion of the feedback response window associated with the second communication. Furthermore, the wireless node resets the DTX counter if the feedback is detected on any feedback occasion. For example, at reference number 1045, the wireless node resets the DTX counter from 2 to 0 based at least in part on feedback being detected (e.g., non-DTX occurring) on any feedback occasion of the feedback response window associated with the first communication or the feedback response window associated with the second communication.

In some aspects, the wireless node increments the DTX counter if no feedback is detected on an mth feedback occasion of the plurality of feedback occasions associated with the PSSCH, where m is less than the total number of feedback occasions of the feedback response window.

In some aspects, the wireless node may increment the DTX counter with regard to a specific feedback opportunity. For example, a transmitting wireless node and a receiving wireless node may agree to perform a legacy RLF detection mechanism for one or more feedback occasions of a plurality of feedback occasions. In some aspects, the transmitting wireless node may maintain a DTX counter according to reception at a soonest feedback occasion. In some aspects, the transmitting wireless node may maintain a DTX counter according to reception of a first triggered HARQ codebook (e.g., a one-shot HARQ codebook, which may be generated in response to a triggering signal).

In example 1100, the communication is associated with feedback occasions 1105, 1110, and 1115. In example 1100, the wireless node increments (e.g., based at least in part on the configuration of the feedback response window) the DTX counter each time no feedback is detected on a feedback occasion of the plurality of feedback occasions. For example, at reference number 1120, the wireless node increments the DTX counter from 0 to 1 based at least in part on no feedback being detected (e.g., DTX occurring) on a first feedback occasion of the feedback response window associated with the communication. At reference number 1125, the wireless node increments the DTX counter from 1 to 2 based at least in part on no feedback being detected (e.g., DTX occurring) on a first feedback occasion of the feedback response window associated with the communication. Furthermore, the wireless node resets the DTX counter if the feedback is detected on any feedback occasion. For example, at reference number 1130, the wireless node resets the DTX counter from 2 to 0 based at least in part on feedback being detected (e.g., non-DTX occurring) on any feedback occasion of the feedback response window associated with the first communication or the feedback response window associated with the second communication.

As indicated above, FIGS. 9-11 are provided as examples. Other examples may differ from what is described with regard to FIGS. 9-11.

FIG. 12 is a diagram illustrating an example process 1200 performed, for example, by a wireless node, in accordance with the present disclosure. Example process 1200 is an example where the wireless node (e.g., UE 120, UE 305, UE 405, UE 410, UE 605, UE 610, the first wireless node of FIG. 8) performs operations associated with techniques for management of feedback based radio link failure in unlicensed sidelink.

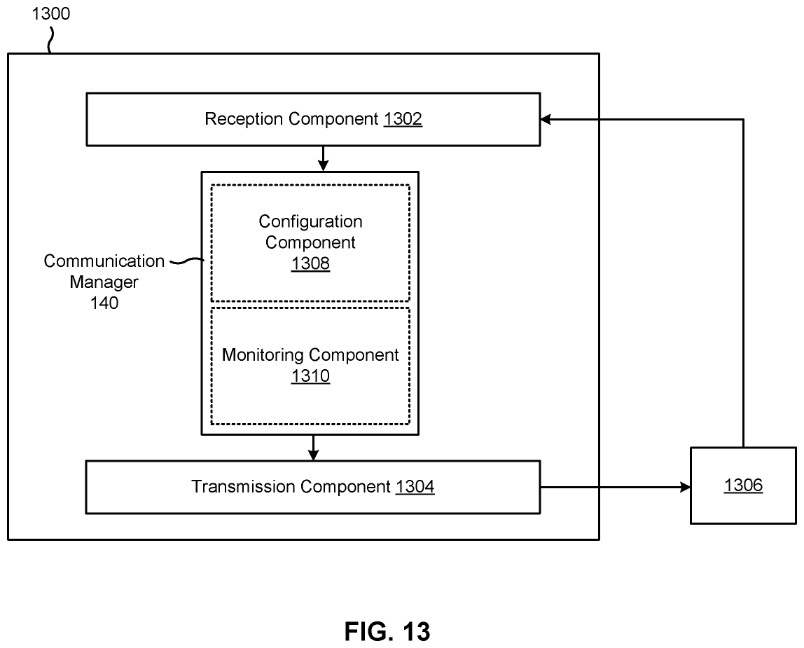

As shown in FIG. 12, in some aspects, process 1200 may include configuring, for a sidelink unicast link, a feedback response window including a plurality of feedback occasions associated with a communication channel (block 1210). For example, the wireless node (e.g., using communication manager 140 and/or configuration component 1308, depicted in FIG. 13) may configure, for a sidelink unicast link, a feedback response window including a plurality of feedback occasions associated with a communication channel, as described above.

As further shown in FIG. 12, in some aspects, process 1200 may include transmitting a communication on the communication channel (block 1220). For example, the wireless node (e.g., using communication manager 140 and/or transmission component 1304, depicted in FIG. 13) may transmit a communication on the communication channel, as described above.

As further shown in FIG. 12, in some aspects, process 1200 may include monitoring for feedback on the plurality of feedback occasions based at least in part on a discontinuous transmission counter, wherein the discontinuous transmission counter is based at least in part on the feedback being associated with the feedback response window (block 1230). For example, the wireless node (e.g., using communication manager 140 and/or monitoring component 1310, depicted in FIG. 13) may monitor for feedback on the plurality of feedback occasions based at least in part on a discontinuous transmission counter, wherein the discontinuous transmission counter is based at least in part on the feedback being associated with the feedback response window, as described above.

Process 1200 may include additional aspects, such as any single aspect or any combination of aspects described below and/or in connection with one or more other processes described elsewhere herein.

In a first aspect, the feedback response window is configured based at least in part on the sidelink unicast link being associated with a decentralized channel access mechanism.

In a second aspect, alone or in combination with the first aspect, the configuration of the feedback response window is associated with establishing the sidelink unicast link with another wireless node, and the configuration of the feedback response window is based at least in part on signaling between the wireless node and the other wireless node.

In a third aspect, alone or in combination with one or more of the first and second aspects, process 1200 includes performing radio link failure (RLF) detection based at least in part on monitoring for the feedback.

In a fourth aspect, alone or in combination with one or more of the first through third aspects, the plurality of feedback occasions are distributed in at least one of a frequency domain or a time domain.

In a fifth aspect, alone or in combination with one or more of the first through fourth aspects, the plurality of feedback occasions are pre-configured for the wireless node.

In a sixth aspect, alone or in combination with one or more of the first through fifth aspects, the plurality of feedback occasions are based at least in part on dynamic triggering.

In a seventh aspect, alone or in combination with one or more of the first through sixth aspects, the monitoring for feedback on the plurality of feedback occasions based at least in part on the discontinuous transmission counter further comprises incrementing the discontinuous transmission counter if no feedback is detected on any feedback occasion of the plurality of feedback occasions, or resetting the discontinuous transmission counter if the feedback is detected on any feedback occasion of the plurality of feedback occasions.

In an eighth aspect, alone or in combination with one or more of the first through seventh aspects, the monitoring for feedback on the plurality of feedback occasions based at least in part on the discontinuous transmission counter further comprises incrementing the discontinuous transmission counter if no feedback is detected on an earliest feedback occasion of the plurality of feedback occasions, or resetting the discontinuous transmission counter if the feedback is detected on any feedback occasion of the plurality of feedback occasions.

In a ninth aspect, alone or in combination with one or more of the first through eighth aspects, the monitoring for feedback on the plurality of feedback occasions based at least in part on the discontinuous transmission counter further comprises incrementing, based at least in part on the configuring, the discontinuous transmission counter each time no feedback is detected on a feedback occasion of the plurality of feedback occasions, and resetting the discontinuous transmission counter if the feedback is detected on any feedback occasion of the plurality of feedback occasions.

In a tenth aspect, alone or in combination with one or more of the first through ninth aspects, process 1200 includes skipping monitoring on a particular feedback occasion of the plurality of feedback occasions.

In an eleventh aspect, alone or in combination with one or more of the first through tenth aspects, the monitoring for feedback on the plurality of feedback occasions based at least in part on the discontinuous transmission counter further comprises monitoring for the feedback as if the particular feedback occasion is not configured.

In a twelfth aspect, alone or in combination with one or more of the first through eleventh aspects, the monitoring for feedback on the plurality of feedback occasions based at least in part on the discontinuous transmission counter further comprises monitoring for the feedback assuming a non-discontinuous transmission result on the particular feedback occasion.

In a thirteenth aspect, alone or in combination with one or more of the first through twelfth aspects, the monitoring for feedback on the plurality of feedback occasions based at least in part on the discontinuous transmission counter further comprises monitoring for the feedback assuming a discontinuous transmission result on the particular feedback occasion.

In a fourteenth aspect, alone or in combination with one or more of the first through thirteenth aspects, the monitoring for feedback on the plurality of feedback occasions based at least in part on the discontinuous transmission counter further comprises monitoring for the feedback based at least in part on a priority of the communication.

In a fifteenth aspect, alone or in combination with one or more of the first through fourteenth aspects, the configuration indicates to monitor only for a non-discontinuous transmission result on a first feedback occasion of the plurality of feedback occasions, and to monitor for a discontinuous transmission result and a non-discontinuous transmission result on a second feedback occasion of the plurality of feedback occasions.

In a sixteenth aspect, alone or in combination with one or more of the first through fifteenth aspects, monitoring for feedback on the plurality of feedback occasions based at least in part on the discontinuous transmission counter further comprises resetting the discontinuous transmission counter upon reception of the feedback including a valid codebook including a response corresponding to any HARQ process for which the wireless node is monitoring for feedback.

In a seventeenth aspect, alone or in combination with one or more of the first through sixteenth aspects, the monitoring for feedback on the plurality of feedback occasions based at least in part on the discontinuous transmission counter further comprises receiving the feedback, and incrementing the discontinuous transmission counter in accordance with a weighted number of negative acknowledgments indicated by a codebook of the feedback.

In an eighteenth aspect, alone or in combination with one or more of the first through seventeenth aspects, the configuration of the feedback response window is based at least in part on an indication associated with a selected mode for the feedback response window.

In a nineteenth aspect, alone or in combination with one or more of the first through eighteenth aspects, the selected mode is based at least in part on a likelihood of a radio link failure of the sidelink unicast link.

In a twentieth aspect, alone or in combination with one or more of the first through nineteenth aspects, the selected mode indicates at least one of a number of the plurality of feedback occasions, whether to duplicate feedback on two or more feedback occasions, whether to provide the feedback via sidelink control information, or whether to provide a feedback codebook indicating three possible states or two possible states.

In a twenty-first aspect, alone or in combination with one or more of the first through twentieth aspects, the indication is provided in sidelink control information, transmitted by the wireless node, that requests a HARQ response from a second wireless node.

In a twenty-second aspect, alone or in combination with one or more of the first through twenty-first aspects, process 1200 includes transmitting, to a network entity, an indication of a likelihood of a radio link failure of the sidelink unicast link, wherein sidelink resources associated with the plurality of feedback occasions are allocated based at least in part on the likelihood of the radio link failure of the sidelink unicast link.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a wireless node (as described in connection with FIG. 12), or a wireless node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include one or more of a configuration component 1308 or a monitoring component 1310, among other examples.

In some aspects, the apparatus 1300 may be configured to perform one or more operations described herein in connection with FIGS. 3-11. Additionally, or alternatively, the apparatus 1300 may be configured to perform one or more processes described herein, such as process 1200 of FIG. 12, or a combination thereof. In some aspects, the apparatus 1300 and/or one or more components shown in FIG. 13 may include one or more components of the wireless node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the wireless node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the wireless node described in connection with FIG. 2. In some aspects, the transmission component 1304 may be co-located with the reception component 1302 in a transceiver.

The configuration component 1308 may configure, for a sidelink unicast link, a feedback response window including a plurality of feedback occasions associated with a communication channel. The transmission component 1304 may transmit a communication on the communication channel. The monitoring component 1310 may monitor for feedback on the plurality of feedback occasions based at least in part on a discontinuous transmission counter, wherein the discontinuous transmission counter is based at least in part on the feedback being associated with the feedback response window.

The monitoring component 1310 may perform RLF detection based at least in part on monitoring for the feedback.

The monitoring component 1310 may skip monitoring on a particular feedback occasion of the plurality of feedback occasions.

The transmission component 1304 may transmit, to a network entity, an indication of a likelihood of a radio link failure of the sidelink unicast link, wherein sidelink resources associated with the plurality of feedback occasions are allocated based at least in part on the likelihood of the radio link failure of the sidelink unicast link.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a wireless node, comprising: configuring, for a sidelink unicast link, a feedback response window including a plurality of feedback occasions associated with a communication channel; transmitting a communication on the communication channel; and monitoring for feedback on the plurality of feedback occasions based at least in part on a discontinuous transmission counter, wherein the discontinuous transmission counter is based at least in part on the feedback being associated with the feedback response window.

Aspect 2: The method of Aspect 1, wherein the feedback response window is configured based at least in part on the sidelink unicast link being associated with a decentralized channel access mechanism.

Aspect 3: The method of any of Aspects 1-2, wherein the configuration of the feedback response window is associated with establishing the sidelink unicast link with another wireless node, and wherein the configuration of the feedback response window is based at least in part on signaling between the wireless node and the other wireless node.

Aspect 4: The method of any of Aspects 1-3, further comprising: performing radio link failure (RLF) detection based at least in part on monitoring for the feedback.

Aspect 5: The method of any of Aspects 1-4, wherein the plurality of feedback occasions are distributed in at least one of a frequency domain or a time domain.

Aspect 6: The method of any of Aspects 1-5, wherein the plurality of feedback occasions are pre-configured for the wireless node.

Aspect 7: The method of any of Aspects 1-5, wherein the plurality of feedback occasions are based at least in part on dynamic triggering.

Aspect 8: The method of any of Aspects 1-7, wherein the monitoring for feedback on the plurality of feedback occasions based at least in part on the discontinuous transmission counter further comprises: incrementing the discontinuous transmission counter if no feedback is detected on any feedback occasion of the plurality of feedback occasions; or resetting the discontinuous transmission counter if the feedback is detected on any feedback occasion of the plurality of feedback occasions.

Aspect 9: The method of any of Aspects 1-8, wherein the monitoring for feedback on the plurality of feedback occasions based at least in part on the discontinuous transmission counter further comprises: incrementing the discontinuous transmission counter if no feedback is detected on an earliest feedback occasion of the plurality of feedback occasions; or resetting the discontinuous transmission counter if the feedback is detected on any feedback occasion of the plurality of feedback occasions.

Aspect 10: The method of any of Aspects 1-9, wherein the monitoring for feedback on the plurality of feedback occasions based at least in part on the discontinuous transmission counter further comprises: incrementing, based at least in part on the configuring, the discontinuous transmission counter each time no feedback is detected on a feedback occasion of the plurality of feedback occasions; and resetting the discontinuous transmission counter if the feedback is detected on any feedback occasion of the plurality of feedback occasions.

Aspect 11: The method of any of Aspects 1-10, further comprising: skipping monitoring on a particular feedback occasion of the plurality of feedback occasions.

Aspect 12: The method of Aspect 11, wherein monitoring for feedback on the plurality of feedback occasions based at least in part on the discontinuous transmission counter further comprises: monitoring for the feedback as if the particular feedback occasion is not configured.

Aspect 13: The method of Aspect 11, wherein the monitoring for feedback on the plurality of feedback occasions based at least in part on the discontinuous transmission counter further comprises: monitoring for the feedback assuming a non-discontinuous transmission result on the particular feedback occasion.

Aspect 14: The method of Aspect 11, wherein the monitoring for feedback on the plurality of feedback occasions based at least in part on the discontinuous transmission counter further comprises: monitoring for the feedback assuming a discontinuous transmission result on the particular feedback occasion.

Aspect 15: The method of Aspect 11, wherein the monitoring for feedback on the plurality of feedback occasions based at least in part on the discontinuous transmission counter further comprises: monitoring for the feedback based at least in part on a priority of the communication.

Aspect 16: The method of any of Aspects 1-15, wherein the configuration indicates to monitor only for a non-discontinuous transmission result on a first feedback occasion of the plurality of feedback occasions, and to monitor for a discontinuous transmission result and a non-discontinuous transmission result on a second feedback occasion of the plurality of feedback occasions.

Aspect 17: The method of any of Aspects 1-16, wherein monitoring for feedback on the plurality of feedback occasions based at least in part on the discontinuous transmission counter further comprises: resetting the discontinuous transmission counter upon reception of the feedback including a valid codebook including a response corresponding to any hybrid automatic repeat request (HARQ) process for which the wireless node is monitoring for feedback.

Aspect 18: The method of any of Aspects 1-17, wherein monitoring for feedback on the plurality of feedback occasions based at least in part on the discontinuous transmission counter further comprises: receiving the feedback; and incrementing the discontinuous transmission counter in accordance with a weighted number of negative acknowledgments indicated by a codebook of the feedback.

Aspect 19: The method of any of Aspects 1-18, wherein the configuration of the feedback response window is based at least in part on an indication associated with a selected mode for the feedback response window.

Aspect 20: The method of Aspect 19, wherein the selected mode is based at least in part on a likelihood of a radio link failure of the sidelink unicast link.

Aspect 21: The method of Aspect 19, wherein the selected mode indicates at least one of: a number of the plurality of feedback occasions, whether to duplicate feedback on two or more feedback occasions, whether to provide the feedback via sidelink control information, or whether to provide a feedback codebook indicating three possible states or two possible states.

Aspect 22: The method of Aspect 19, wherein the indication is provided in sidelink control information, transmitted by the wireless node, that requests a hybrid automatic repeat request (HARQ) response from a second wireless node.

Aspect 23: The method of any of Aspects 1-22, further comprising: transmitting, to a network entity, an indication of a likelihood of a radio link failure of the sidelink unicast link, wherein sidelink resources associated with the plurality of feedback occasions are allocated based at least in part on the likelihood of the radio link failure of the sidelink unicast link.

Aspect 24: An apparatus for wireless communication at a device, comprising a processor; memory coupled with the processor; and instructions stored in the memory and executable by the processor to cause the apparatus to perform the method of one or more of Aspects 1-23.

Aspect 25: A device for wireless communication, comprising a memory and one or more processors coupled to the memory, the one or more processors configured to perform the method of one or more of Aspects 1-23.

Aspect 26: An apparatus for wireless communication, comprising at least one means for performing the method of one or more of Aspects 1-23.

Aspect 27: A non-transitory computer-readable medium storing code for wireless communication, the code comprising instructions executable by a processor to perform the method of one or more of Aspects 1-23.

Aspect 28: A non-transitory computer-readable medium storing a set of instructions for wireless communication, the set of instructions comprising one or more instructions that, when executed by one or more processors of a device, cause the device to perform the method of one or more of Aspects 1-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A wireless node for wireless communication, comprising:
a memory; and
one or more processors, coupled to the memory, configured to cause the wireless node to:
configure, for a sidelink unicast link, a feedback response window including a plurality of feedback occasions associated with a communication channel;
transmit a communication on the communication channel; and
monitor for feedback on the plurality of feedback occasions based at least in part on a discontinuous transmission counter, wherein the discontinuous transmission counter is based at least in part on the feedback being associated with the feedback response window.

2. The wireless node of claim 1, wherein the feedback response window is configured based at least in part on the sidelink unicast link being associated with a decentralized channel access mechanism.

3. The wireless node of claim 1, wherein the configuration of the feedback response window is associated with establishing the sidelink unicast link with another wireless node, and wherein the configuration of the feedback response window is based at least in part on signaling between the wireless node and the other wireless node.

4. The wireless node of claim 1, wherein the one or more processors are further configured to cause the wireless node to:
perform radio link failure (RLF) detection based at least in part on monitoring for the feedback.

5. The wireless node of claim 1, wherein the plurality of feedback occasions are distributed in at least one of a frequency domain or a time domain.

6. The wireless node of claim 1, wherein the plurality of feedback occasions are pre-configured for the wireless node.

7. The wireless node of claim 1, wherein the plurality of feedback occasions are based at least in part on dynamic triggering.

8. The wireless node of claim 1, wherein, to monitor for feedback on the plurality of feedback occasions based at least in part on the discontinuous transmission counter, the one or more processors are configured to cause the wireless node to:
increment the discontinuous transmission counter if no feedback is detected on any feedback occasion of the plurality of feedback occasions; or
reset the discontinuous transmission counter if the feedback is detected on any feedback occasion of the plurality of feedback occasions.

9. The wireless node of claim 1, wherein, to monitor for feedback on the plurality of feedback occasions based at least in part on the discontinuous transmission counter, the one or more processors are configured to cause the wireless node to:
increment the discontinuous transmission counter if no feedback is detected on an earliest feedback occasion of the plurality of feedback occasions; or
reset the discontinuous transmission counter if the feedback is detected on any feedback occasion of the plurality of feedback occasions.

10. The wireless node of claim 1, wherein, to monitor for feedback on the plurality of feedback occasions based at least in part on the discontinuous transmission counter, the one or more processors are configured to cause the wireless node to:
increment, based at least in part on the configuring, the discontinuous transmission counter each time no feedback is detected on a feedback occasion of the plurality of feedback occasions; and
reset the discontinuous transmission counter if the feedback is detected on any feedback occasion of the plurality of feedback occasions.

11. The wireless node of claim 1, wherein the one or more processors are further configured to cause the wireless node to:
skip monitoring on a particular feedback occasion of the plurality of feedback occasions.

12. The wireless node of claim 11, wherein, to monitor for feedback on the plurality of feedback occasions based at least in part on the discontinuous transmission counter, the one or more processors are configured to cause the wireless node to:
monitor for the feedback as if the particular feedback occasion is not configured.

13. The wireless node of claim 11, wherein, to monitor for feedback on the plurality of feedback occasions based at least in part on the discontinuous transmission counter, the one or more processors are configured to cause the wireless node to:
monitor for the feedback assuming a non-discontinuous transmission result on the particular feedback occasion.

14. The wireless node of claim 11, wherein, to monitor for feedback on the plurality of feedback occasions based at least in part on the discontinuous transmission counter, the one or more processors are configured to cause the wireless node to:
monitor for the feedback assuming a discontinuous transmission result on the particular feedback occasion.

15. The wireless node of claim 11, wherein, to monitor for feedback on the plurality of feedback occasions based at least in part on the discontinuous transmission counter, the one or more processors are configured to cause the wireless node to:
monitor for the feedback based at least in part on a priority of the communication.

16. The wireless node of claim 1, wherein the configuration indicates to monitor only for a non-discontinuous transmission result on a first feedback occasion of the plurality of feedback occasions, and to monitor for a discontinuous transmission result and a non-discontinuous transmission result on a second feedback occasion of the plurality of feedback occasions.

17. The wireless node of claim 1, wherein, to monitor for feedback on the plurality of feedback occasions based at least in part on the discontinuous transmission counter, the one or more processors are configured to cause the wireless node to:
reset the discontinuous transmission counter upon reception of the feedback including a valid codebook including a response corresponding to any hybrid automatic repeat request (HARQ) process for which the wireless node is monitoring for feedback.

18. The wireless node of claim 1, wherein, to monitor for feedback on the plurality of feedback occasions based at least in part on the discontinuous transmission counter, the one or more processors are configured to cause the wireless node to:
receive the feedback; and
increment the discontinuous transmission counter in accordance with a weighted number of negative acknowledgments indicated by a codebook of the feedback.

19. The wireless node of claim 1, wherein the configuration of the feedback response window is based at least in part on an indication associated with a selected mode for the feedback response window.

20. The wireless node of claim 19, wherein the selected mode is based at least in part on a likelihood of a radio link failure of the sidelink unicast link.

21. The wireless node of claim 19, wherein the selected mode indicates at least one of:
a number of the plurality of feedback occasions,
whether to duplicate feedback on two or more feedback occasions,
whether to provide the feedback via sidelink control information, or
whether to provide a feedback codebook indicating three possible states or two possible states.

22. The wireless node of claim 19, wherein the indication is provided in sidelink control information, transmitted by the wireless node, that requests a hybrid automatic repeat request (HARQ) response from a second wireless node.

23. The wireless node of claim 1, wherein the one or more processors are further configured to cause the wireless node to:
transmit, to a network entity, an indication of a likelihood of a radio link failure of the sidelink unicast link, wherein sidelink resources associated with the plurality of feedback occasions are allocated based at least in part on the likelihood of the radio link failure of the sidelink unicast link.

24. A method of wireless communication performed by a wireless node, comprising:
configuring, for a sidelink unicast link, a feedback response window including a plurality of feedback occasions associated with a communication channel;
transmitting a communication on the communication channel; and
monitoring for feedback on the plurality of feedback occasions based at least in part on a discontinuous transmission counter, wherein the discontinuous transmission counter is based at least in part on the feedback being associated with the feedback response window.

25. The method of claim 24, wherein the feedback response window is configured based at least in part on the sidelink unicast link being associated with a decentralized channel access mechanism.

26. The method of claim 24, wherein the configuration of the feedback response window is associated with establishing the sidelink unicast link with another wireless node, and wherein the configuration of the feedback response window is based at least in part on signaling between the wireless node and the other wireless node.

27. The method of claim 24, further comprising:
performing radio link failure (RLF) detection based at least in part on monitoring for the feedback.

28. A non-transitory computer-readable medium storing a set of instructions for wireless communication, the set of instructions comprising:
one or more instructions that, when executed by one or more processors of a wireless node, cause the wireless node to:
configure, for a sidelink unicast link, a feedback response window including a plurality of feedback occasions associated with a communication channel;
transmit a communication on the communication channel; and
monitor for feedback on the plurality of feedback occasions based at least in part on a discontinuous transmission counter, wherein the discontinuous transmission counter is based at least in part on the feedback being associated with the feedback response window.

29. The non-transitory computer-readable medium of claim 28, wherein the feedback response window is configured based at least in part on the sidelink unicast link being associated with a decentralized channel access mechanism.

30. An apparatus for wireless communication, comprising:
means for configuring, for a sidelink unicast link, a feedback response window including a plurality of feedback occasions associated with a communication channel;
means for transmitting a communication on the communication channel; and
means for monitoring for feedback on the plurality of feedback occasions based at least in part on a discontinuous transmission counter, wherein the discontinuous transmission counter is based at least in part on the feedback being associated with the feedback response window.
